(19) United States
(12) Patent Application Publication
(10) Pub. No.: US 2007/0253038 A1
(43) Pub. Date: Nov. 1, 2007

(54) SHEET-FED IMAGE-SCANNING APPARATUS

(76) Inventors: Ta-Yi Lee, Taipei County (TW); Chi-Feng Chen, Taipei City (TW); Zero Song, Guangzhou (CN); Danny Xiao, Chongqing City (CN); Frank Ai, Nanchang City (CN); Lily Luo, Zhuzhou City (CN); Jeicy Lee, Guangzhou (CN); JY Tang, Xiangtan City (CN); Judy Hu, Nanzhang County (CN)

Correspondence Address: NORTH AMERICA INTELLECTUAL PROPERTY CORPORATION, P.O. BOX 506, MERRIFIELD, VA, 22116, US

(21) Appl. No.: 11/428,401

(22) Filed: Jul. 2, 2006

(30) Foreign Application Priority Data
Apr. 26, 2006 (TW) 095114930

(51) Int. Cl. H04N 1/04

(52) U.S. Cl. 358/498

(57) ABSTRACT

A sheet-fed image-scanning apparatus for scanning an object on a tray is disclosed and includes a rigid mainframe, a carriage module, a second light source, a transmission module, and a holding module. The rigid mainframe provides a moving route for the tray to be moved into or out from the sheet-fed image-scanning apparatus. The carriage module illuminates the object and senses the light reflected from or penetrated through the object so as to scan the image of the object. The second light source illuminates the object from a position opposite to the carriage module. The transmission module moves the tray into and out from the sheet-fed image-scanning apparatus. The holding module keeps the tray from deviation while the tray is moving within the moving route.

### BACKGROUND OF THE INVENTION

1. Field of the Invention

The invention relates to sheet-fed image-scanning apparatus, and more particularly, to a sheet-fed image-scanning apparatus that comprises a rigid mainframe allowing other components of the sheet-fed image-scanning apparatus to be mounted thereon.

2. Description of the Prior Art

Image-scanning apparatuses, such as scanners, printers, and multi-function printers (MFPs), are a kind of electronic devices frequently used in homes and offices. Generally speaking, image-scanning apparatuses can be divided into two types: sheet-fed image-scanning apparatuses and flat-bed image-scanning apparatuses. Comparing with flat-bed image-scanning apparatuses, sometimes sheet-fed image-scanning apparatuses are more easy to operate.

Sometimes trays are provided as accompaniments of a sheet-fed image-scanning apparatus so that an object to be scanned can be put on one of the trays. While a tray having an object put thereon is moving into or moving out from the sheet-fed image-scanning apparatus, a light source of the sheet-fed image-scanning apparatus will illuminate the object. A sensing module, which can be a Charge Coupled Device (CCD), of the sheet-fed image-scanning apparatus then detects light reflected from or penetrated through the object so as to scan the image of the object. To allow the tray to move into or move out from the scanner freely, the sheet-fed image-scanning apparatus must have a moving route that allows the tray to move within.

A sheet-fed image-scanning apparatus of the prior art has a main body that is constructed by combining two plastic components. The vacant space between the two plastic components serves as the moving route. The plastic component above the moving route allows a sensing module and a first light source to be mounted on. The plastic component beneath the moving route allows a second light source to be mounted on. The second light source is utilized when the object on the tray is a transparency document; the first light source is utilized when the object on the tray is a reflective document. Other components, such as a transmission module that moves the tray into and out from the sheet-fed image-scanning apparatus, are mounted on the main body formed by the two plastic components. To let the sheet-fed image-scanning apparatus be robust and durable enough, the two plastic components cannot be too small. This fact hinders the sheet-fed image-scanning apparatus from being physically minimized. Besides, it's not easy to achieve high precision when manufacturing plastic components. If the shape or size of any one of the two plastic components is different from expected, the two plastic components might not allow tight combination. If the two plastic components are not tightly combined together, the sheet-fed image-scanning apparatus might tremble while performing a scanning operation. Undesired noise is then generated and the scanning quality of the sheet-fed image-scanning apparatus is deteriorated.

### SUMMARY OF THE INVENTION

One of the objectives of the present invention is to provide a sheet-fed image-scanning apparatus that has smaller size.

According to an embodiment of the present invention, a sheet-fed image-scanning apparatus for scanning the image of an object put on a tray is disclosed. The sheet-fed image-scanning apparatus comprises a rigid mainframe, a carriage module, a transmission module, a holding module, and a second light source. The rigid mainframe provides a moving route that allows the tray to be moved into and out from the sheet-fed image-scanning apparatus. The carriage module is mounted on the rigid mainframe and located on a first vertical side of the moving route. The carriage module comprises a first light source for illuminating the object. The transmission module is mounted on the rigid mainframe and is responsible for moving the tray into and out from the sheet-fed image-scanning apparatus. The holding module is mounted on the rigid mainframe and keeps the tray from deviation while the tray is moving within the moving route. The second light source is mounted on the rigid mainframe and located on a second vertical side of the moving route, and is responsible for illuminating the object. The carriage module further comprises a sensing module for detecting light reflected from or penetrated through the object so as to scan the image of the object.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 shows an overall view of an exemplary sheet-fed image-scanning apparatus of the present invention.

FIG. 2 shows a view of the rigid mainframe.

FIG. 3 shows a view of the rigid mainframe combined with the second light source.

FIG. 4 shows a view of the rigid mainframe combined with the transmission module.

FIG. 5 shows a view of the rigid mainframe combined with the holding module.

FIG. 6 shows another view of the rigid mainframe combined with the holding module.

FIG. 7 shows a top view of the carriage module.

FIG. 8 shows a bottom view of the carriage module.

### DETAILED DESCRIPTION

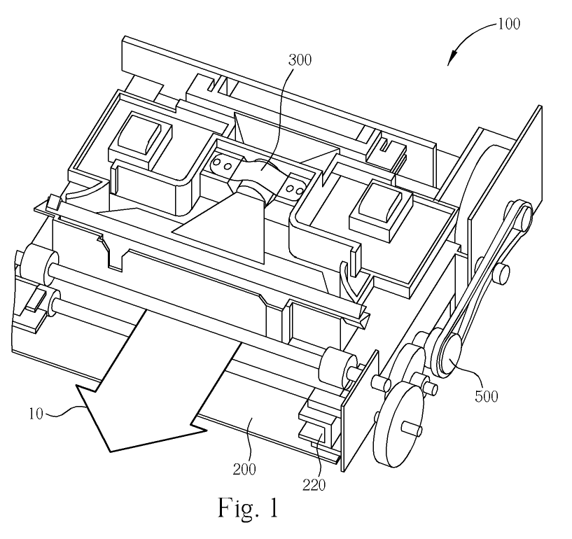

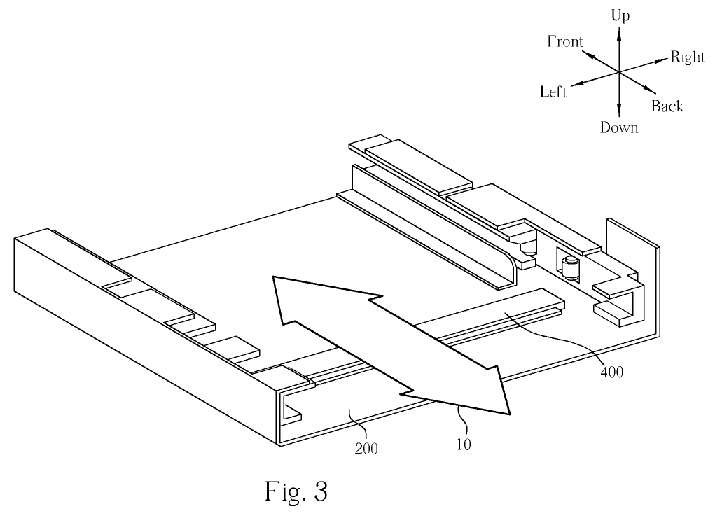

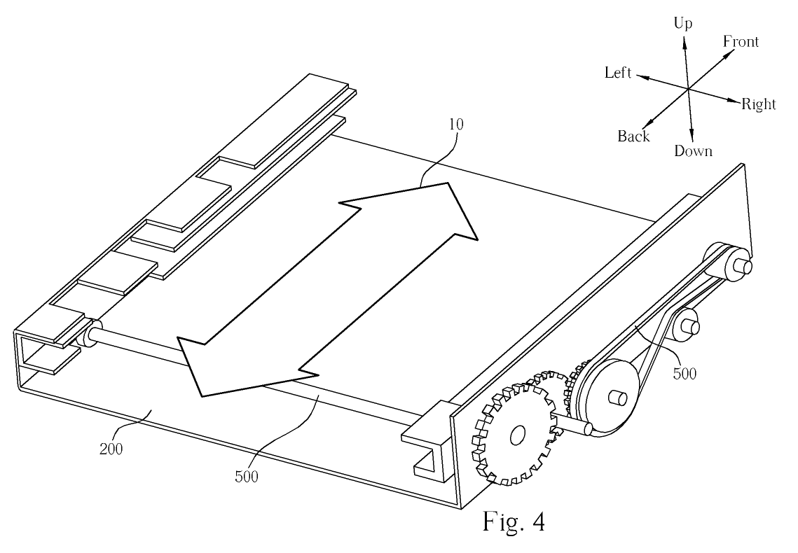

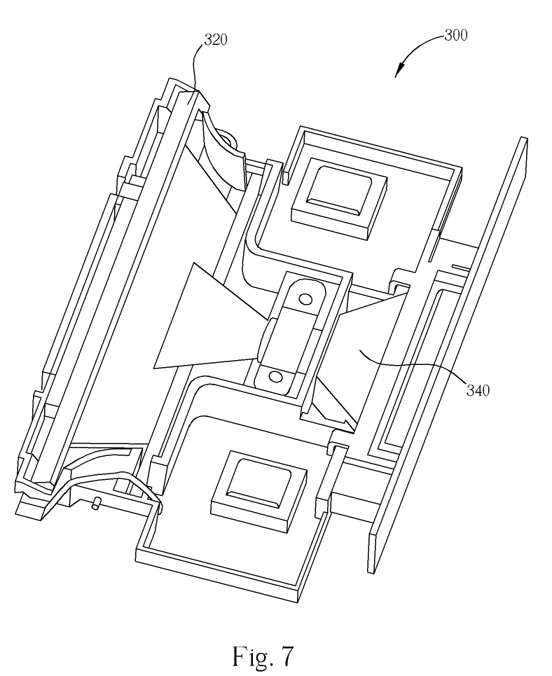

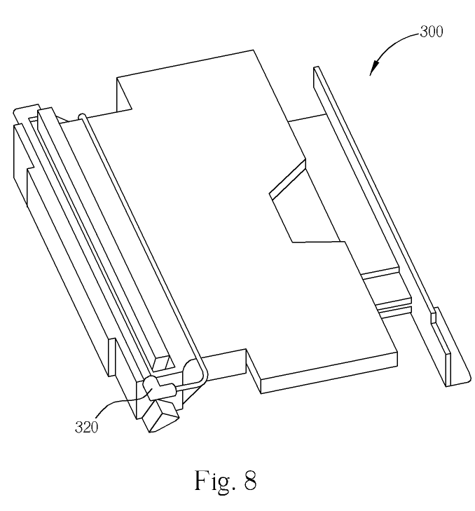

FIG. 1 to FIG. 8 show a sheet-fed image-scanning apparatus 100 according to an embodiment of the present invention. The sheet-fed image-scanning apparatus 100 of this embodiment is used to scan the image of an object put on a tray, where both the object and the tray are not shown in these figures. As is shown by these figures, the sheet-fed image scanning apparatus 100 comprises five main components, as listed below:

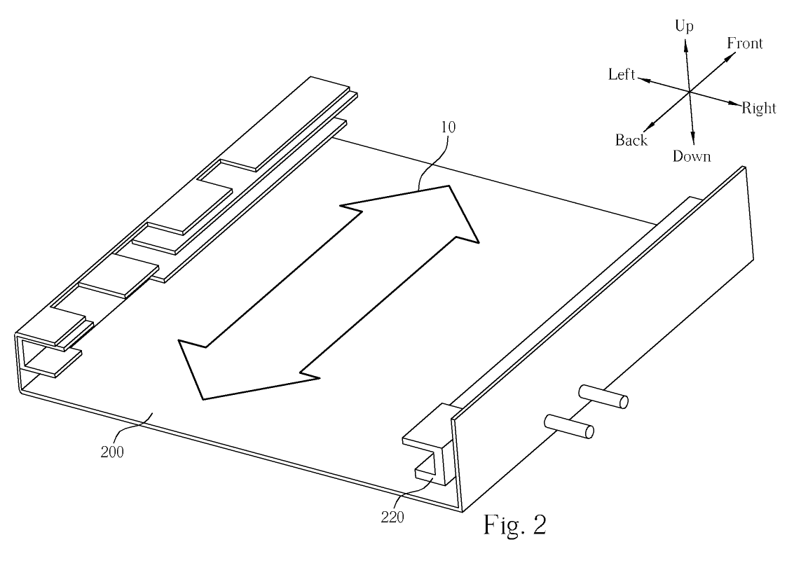

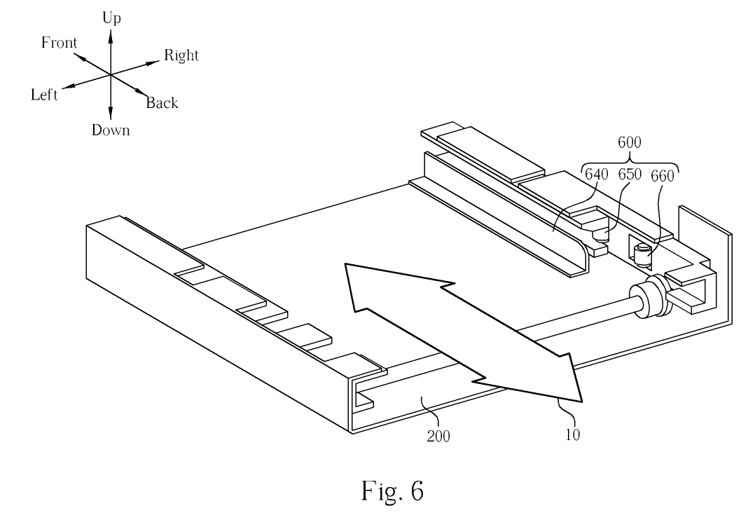

1. A rigid mainframe 200 made up of metal or other material of high rigidity. The rigid mainframe 200 provides a moving route 10, which allows the tray to move into or out from the sheet-fed image-scanning apparatus 100. The rigid mainframe also serves as a main body so that other components of the sheet-fed image-scanning apparatus 100 can be mounted thereon. Aside from the main components that will be introduced later, the rigid mainframe 200 is equipped with a tray-sensing unit 220 that detects whether the tray is put at the entrance of the moving route 10 or not. The moving route 10 has a first vertical side, a second vertical side, a first lateral side, and a second lateral side. Referring to the directions labeled on FIG. 2˜FIG. 6, in this embodiment the up and down sides serve as the first and second vertical sides of the moving route 10 respectively, and the right and left sides serve as the first and second lateral sides of the moving route 10 respectively. However, the directions can also be reversed.

2. A carriage module 300 mounted on the rigid mainframe 200. The carriage module 300 is located on the up side of the moving route 10 and comprises a first light source 320 and a sensing module 340. The first light source 320 illuminates the object on the tray when the object is a reflective document. The sensing module 340, which can be implemented by a CCD, detects light reflect from or penetrated through the object so as to scan the image of the object.

3. A second light source 400 mounted on the rigid mainframe 200. The second light source 400 is located on the down side of the moving route 10 and illuminates the object on the tray when the object is a transparency document.

4. A transmission module 500 mounted on the rigid mainframe 200. The transmission module 500 is responsible for moving the tray into and out from the sheet-fed image-scanning apparatus 100.

5. A holding module 600 mounted on the rigid mainframe 200. The holding module 600 keeps the tray from deviation while the tray is moving within the moving route 10.

Rather than providing a moving route by combining two plastic components, in this embodiment the moving route 10 is provided by the rigid mainframe 200. Since the rigid mainframe 200 is made up of metal or other rigid material, it is robust and durable even if its volume is small. In other words, the sheet-fed image-scanning apparatus 100 of this embodiment can be smaller than the sheet-fed image-scanning apparatuses of the prior art. Another benefit of utilizing the rigid mainframe 200 is that comparing with plastic components, the rigid mainframe 200 can be manufactured with high precision.

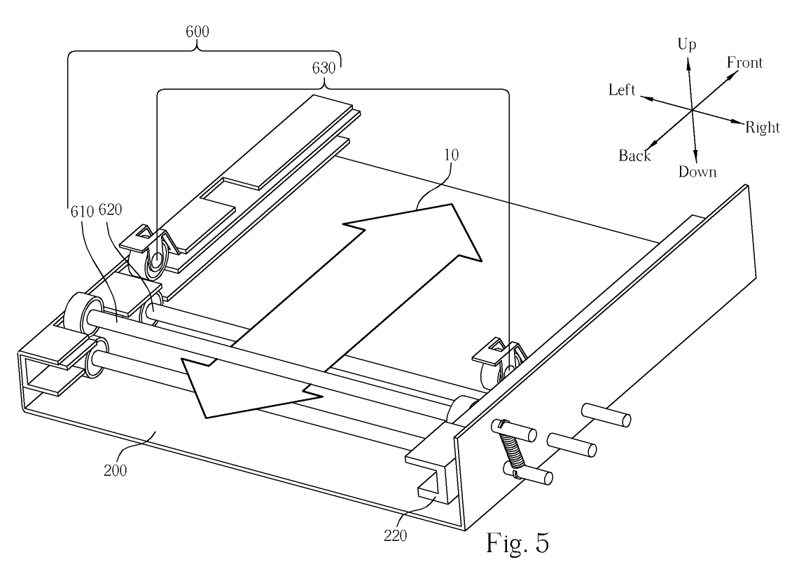

In addition, as is shown in FIG. 5, the holding module 600 comprises a first holding unit pair 610, a second holding unit pair 620, and a third holding unit pair 630. In this embodiment, the first holding unit pair 610 having two mutually dependent vertical holding units is realized by a first holding wheel pair 610 having two vertical holding wheels interconnected by an axle. The first holding wheel pair 610 is mounted on the rigid mainframe 200 and located on the up side of the moving route 10. While the tray is moving within the moving route 10, the first holding wheel pair 610 applies a force on the tray toward the down side of the moving route 10. The second holding unit pair 620 having two mutually dependent vertical holding units is realized by a second holding wheel pair 620 having two vertical holding wheels interconnected by an axle. The second holding wheel pair 620 is mounted on the rigid mainframe 200 and located on the down side of the moving route 10. While the tray is moving within the moving route 10, the second holding wheel pair 620 applies a force on the tray toward the up side of the moving route 10. The structure of the third holding unit pair 630 is unique and different from that of the first and second holding wheel pairs 610 and 620. More specifically, the third holding unit pair 630 having two mutually independent vertical holding units is realized by a third holding wheel pair 630 having two vertical holding wheels, which are not interconnected by an axle. The third holding wheel pair 630 is mounted on the rigid mainframe 200 and located on the up side of the moving route 10. While the tray is moving within the moving route 10, each of the two holding wheels of the third holding wheel pair 630 applies a force on the tray toward the down side of the moving route 10.

Besides, as is shown in FIG. 6, to prevent the tray from laterally deviating from the moving route 10, the holding module 600 further comprises a guiding track 640 and two lateral holding units 650 and 660. The guiding track 640 is mounted on the rigid mainframe 200 and located on the down side of the moving route 10. The tray has a groove thereunder corresponding to the guiding track 640 on the rigid mainframe 200. While the tray is moving within the moving route 10, the guiding track 640 combines with the groove on the tray, so that the tray is kept from lateral deviation. In another embodiment, the holding module 600 comprises a groove set on the rigid mainframe 200 beneath the moving route 10 while the tray has a guiding track thereunder. While the tray is moving within the moving route 10, the guiding track of the tray combines with the groove on the rigid mainframe 200, so that the tray is kept from lateral deviation. As the two lateral holding units 650 and 660, both of them are mounted on the rigid mainframe 200 and located on the right side of the moving route 10. While the tray is moving within the moving route 10, each of the two lateral holding units 650 and 660 applies a force on the tray toward the left side of the moving route 10. The aforementioned components that hold the tray laterally are unique and are not included in the sheet-fed image-scanning apparatuses of the prior art.

Although the sheet-fed image-scanning apparatus 100 includes both the first light source 320 and the second light source 400, however, in other embodiments of the present invention the sheet-fed image-scanning apparatus 100 can also include only one of the first light source 320 and the second light source 400. If the sheet-fed image-scanning apparatus 100 includes the first light source 320 but not the second light source 400, the sheet-fed image-scanning apparatus 100 can only be used to scan reflective documents. If the sheet-fed image-scanning apparatus 100 includes the second light source 400 but not the first light source 320, the sheet-fed image-scanning apparatus 100 can only be used to scan transparency documents.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A sheet-fed image-scanning apparatus for scanning the image of an object on a tray, the sheet-fed image-scanning apparatus comprising:
a rigid mainframe, for providing a moving route that allows the tray to be moved into and out from the sheet-fed image-scanning apparatus; and
a carriage module mounted on the rigid mainframe, the carriage module being located on a first vertical side of the moving route and comprising:
a first light source, for illuminating the object; and
a sensing module, for detecting light reflected from the object so as to scan the image of the object.

2. The sheet-fed image-scanning apparatus of claim 1, further comprising:
a transmission module mounted on the rigid mainframe, for moving the tray into and out from the sheet-fed image-scanning apparatus; and
a holding module mounted on the rigid mainframe, for keeping the tray from deviation while the tray is moving within the moving route.

3. The sheet-fed image-scanning apparatus of claim 2, wherein the holding module comprises:
a lateral holding unit mounted on the rigid mainframe, the lateral holding unit being located on a first lateral side of the moving route, for applying a force on the tray toward a second lateral side of the moving route while the tray is moving within the moving route.

4. The sheet-fed image-scanning apparatus of claim 2, wherein the holding module comprises:
a third holding unit pair, the third holding unit pair comprising two mutually independent vertical holding units mounted on the rigid mainframe and located on the first vertical side of the moving route, each of the two vertical holding units applying a force on the tray toward a second vertical side of the moving route while the tray is moving within the moving route.

5. The sheet-fed image-scanning apparatus of claim 2, wherein the holding module comprises:
a third holding unit pair, the third holding unit pair comprising two mutually independent vertical holding units mounted on the rigid mainframe and located on a second vertical side of the moving route, each of the two vertical holding units applying a force on the tray toward the first vertical side of the moving route while the tray is moving within the moving route.

6. The sheet-fed image-scanning apparatus of claim 2, wherein the tray comprises a groove, and the holding module comprises:
a guiding track mounted on the rigid mainframe, the guiding track combining with the groove while the tray is moving within the moving route so that the tray is kept from deviation.

7. The sheet-fed image-scanning apparatus of claim 2, wherein the tray comprises a guiding track, and the holding module comprises:
a groove set on the rigid mainframe, the groove combining with the guiding track while the tray is moving within the moving route so that the tray is kept from deviation.

8. The sheet-fed image-scanning apparatus of claim 1, further comprising:
a second light source mounted on the rigid mainframe and located on a second vertical side of the moving route, for illuminating the object;
wherein the sensing module detects light reflected from or penetrated through the object so as to scan the image of the object.

9. The sheet-fed image-scanning apparatus of claim 1, wherein the rigid mainframe is made up of metal.

10. A sheet-fed image-scanning apparatus for scanning the image of an object put on a tray, the sheet-fed image-scanning apparatus comprising:
a rigid mainframe, for providing a moving route that allows the tray to be moved into and out from the sheet-fed image-scanning apparatus;
a second light source mounted on the rigid mainframe and located on a second vertical side of the moving route, for illuminating the object; and
a carriage module mounted on the rigid mainframe, the carriage module being located on a first vertical side of the moving route and comprising:
a sensing module, for detecting light penetrated through the object so as to scan the image of the object.

11. The sheet-fed image-scanning apparatus of claim 10, further comprising:
a transmission module mounted on the rigid mainframe, for moving the tray into and out from the sheet-fed image-scanning apparatus; and
a holding module mounted on the rigid mainframe, for keeping the tray from deviation while the tray is moving within the moving route.

12. The sheet-fed image-scanning apparatus of claim 11, wherein the holding module comprises:
a lateral holding unit mounted on the rigid mainframe, the lateral holding unit being located on a first lateral side of the moving route, for applying a force on the tray toward a second lateral side of the moving route while the tray is moving within the moving route.

13. The sheet-fed image-scanning apparatus of claim 11, wherein the holding module comprises:
a third holding unit pair, the third holding unit pair comprising two mutually independent vertical holding units mounted on the rigid mainframe and located on the first vertical side of the moving route, each of the two vertical holding units applying a force on the tray toward the second vertical side of the moving route while the tray is moving within the moving route.

14. The sheet-fed image-scanning apparatus of claim 11, wherein the holding module comprises:
a third holding unit pair, the third holding unit pair comprising two mutually independent vertical holding units mounted on the rigid mainframe and located on the second vertical side of the moving route, each of the two vertical holding units applying a force on the tray toward the first vertical side of the moving route while the tray is moving within the moving route.

15. The sheet-fed image-scanning apparatus of claim 11, wherein the tray comprises a groove, and the holding module comprises:
a guiding track mounted on the rigid mainframe, the guiding track combining with the groove while the tray is moving within the moving route so that the tray is kept from deviation.

16. The sheet-fed image-scanning apparatus of claim 11, wherein the tray comprises a guiding track, and the holding module comprises:
a groove set on the rigid mainframe, the groove combining with the guiding track while the tray is moving within the moving route so that the tray is kept from deviation.

17. The sheet-fed image-scanning apparatus of claim 10, wherein the carriage module further comprises:
a first light source, for illuminating the object;
wherein the sensing module detects light reflected from or penetrated through the object so as to scan the image of the object.

18. The sheet-fed image-scanning apparatus of claim 10, wherein the rigid mainframe is made up of metal.
